(19) United States
(12) Patent Application Publication
(10) Pub. No.: US 2005/0230978 A1
(43) Pub. Date: Oct. 20, 2005

(54) Solar/wind actuated faraday principle turbine generator

(76) Inventor: James Robert McGovern, Yorktown Heights, NY (US)

Correspondence Address: James Robert McGovern, 63 (B) Independence Court, Yorktown Heights, NY, 10598, US

(21) Appl. No.: 10/417,396

(22) Filed: Apr. 17, 2003

(51) Int. Cl. F03D 9/00; H02P 9/04

(52) U.S. Cl. 290/44

(57) ABSTRACT

A wind actuated turbine which causes a permanent maqnet-brush spinner and a copper foil covered disk spinner to counter rotate and generate electricity by the Faraday Principle is improved by fastening a solar recharged battery driven electromagnet to the spinner to work in combination with the generators permanent magnet brush, and by changing the disk from its solid form to one that has multiple copper radian spokes that constitute magnetic force line cutters, as the spoked disk counter rotates through the rotating magnetic lines of force of the generator.

### BACKGROUND

The invention of U.S. Pat. No. 4,328,428 can undoubtedly produce a small amount of current that could be increased by redesigning the the generators armature, and it could undoubtedly be increased by increasing the strength of the magnetic field of the generator. The present invention addresses the concept of improving strength of field, and the concept of improving the generator's armature design. (see Provisional Patent Application No. 60/372,693 File Date Apr. 15, 2002)

### SUMMARY

It is therefore the object of the present invention to provide the means of improving the strength of the U.S. Pat. No. 4,328,428 generator's magnetic field.

It is also an object of the present invention to provide an elecromagnetic field to work in combination with the U.S. Pat. No. 4,328,428 generator permanent magnetic field.

And it is also an object of the present invention to employ a rechargeable battery means of energizing the proposed electromagnet.

And it is likewise an object of the present invention to provide a means of recharging the unit's battery by using windspinner produced solar current, and a battery charger.

And further it is an object of the present invention to provide an alternate embidiment of 4,328,428 generators copper disk armature.

And in keeping with the above object, it is an object of the present invention to provide an armature that has multiple copper radians, that resemble spokes in a wheel.

And again, further, it is an object of the present invention to provide a generator armature that cuts the generators magnetic lines of force in rapid succession, that is, as each armature radian passes through the generators magnetic line(s).

A still further object of the present invention is to provide a generator armature where each individual radian constitutes a viable circuit of the armature, and is a conductor line connecting a brush point on the armature's hub, and a brush point on the armature's circular outer edge.

Another object of the invention is to provide solar cells in panels fastened to the outer surface of the turbine's radially dosposed vertical vanes, wired in circuit with a battery charger and battery.

Further objects of the invention will become obvious as the specification and drawings of the wind actuated turbine generator are examined.

Typically, another object of the invention that has become obvious is to provide generator current circuit capability of sweeping current from the generator armature's right side and left side simultaneously.

### DRAWINGS

FIG. 1 is a side elevation view of the inventions windspinner turbine that includes a simulated placement of the inventions battery charger, battery, and solar collector panels and their current gathering units.

FIG. 2 is a top view of the windspinners rotated magnetic field spinner, its counter rotated armature, and a simulated illustration of rotational torque power being imparted from the windspinner's interior through the transmission rotationally to the magnet field spinner and counter rotationally to the generator armature.

FIG. 3 shows and elevation view of the interior that identifies the placement of the generators rotational apparatus—its permanent magnet/electromagnet-brush spinner and its armature.

FIG. 4 shows in elevation an enlarged view of the embodiment of the inventions improved magnetic field apparatus, a combination of a permanent magnet and electromagnet magnetic field magnet spinner and the armature.

FIG. 5 is a plan view of the inventions improved armature, here shown as a radian magnetic line cutter disk with its spoked frame, depicting a simulated placement of the generator's magnetic field magnets, and the armature disk's single line copper radian magnetic-line-of force cutting circuit strips.

FIG. 6 is an elevation view of the elongated hub pulley showing copper radian magnetic line cutting strips supported by the spoked armature frame, fastened in grooves that extend vertically along the sides of the pulley.

FIG. 7 shows deployed solar cells on the windspinner turbin's vanes, concentric channel solar electric current collectors mounted on top of the generator's turbine, a channel current sweep probe, mounted, supported to a generator support arm, and lines that carry current to a battery charger.

### SPECIFICATION

In order to construct this improved Faraday Principle wind driven electric current producing generator 1, provide:

A) A Veined Windspinner Turbine

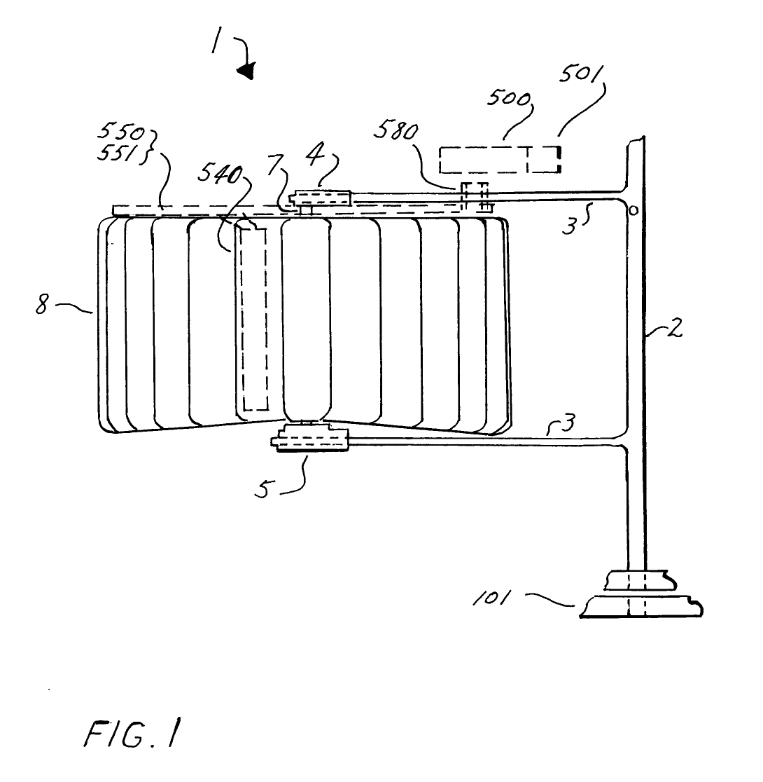

With reference to FIG. 1 provide a windspinner generator unit 1 base 101 that carries a vertical rod 2 that has two horizontal support arms 3.

Each arm 3 has an elongated rectangular shape at its unfastened end.

Provide a rectangular shaped bearing piece 4 on the unfastened end of the top arm 3, and a rectangular shaped bearing piece 5 on the unfastened end of the bottom arm 3.

Each bearing piece, 4 and 5, has a squared recess hole 450 cut into it on one of its sides, (Not shown.)

Each bearing piece, 4 and 5, is held in a stationary position on the arm 3 by a set screw 6. (Not shown.)

Provide a generator 1 shaft 7, held vertically disposed with its square ends set in the square recess holes 450 of the end pieces 4 and 5. (Not shown.)

Continuing, provide a windspinner 8 that is shaped like the veined turbine shown in FIG. 1.

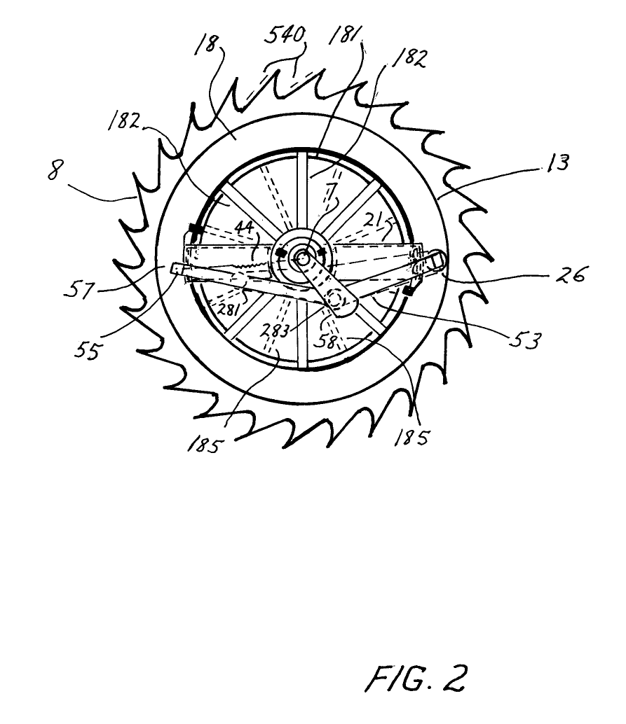

The windspinner turbine 8 could be constructed by glue laminating and reinforcing pieces of styrofoam or other light weight plastic material that is cut or made with the shape or configuration of 8 shown in FIG. 1 and in FIG. 2.

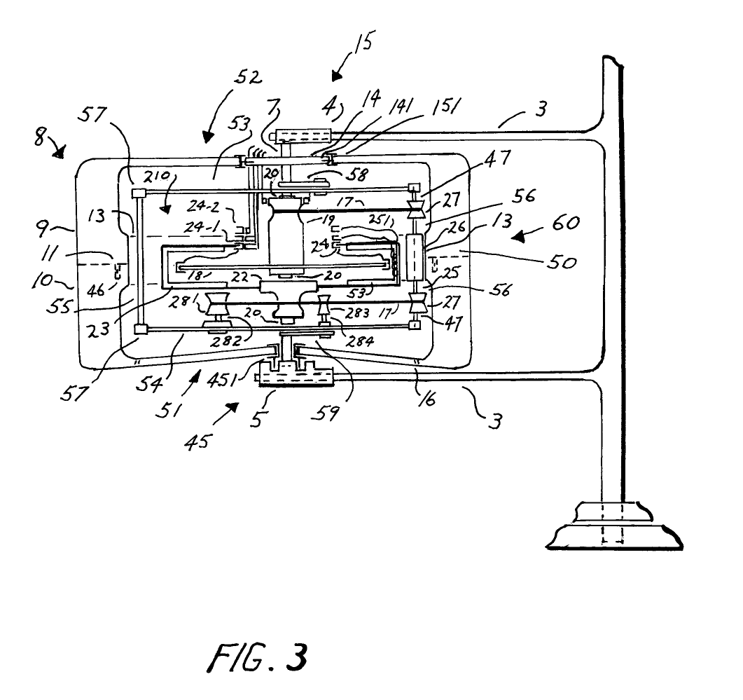

Now, with reference to FIG. 3, provide the windspinner turbine 8 with bearing assemblies that could possibly be made from nylon, steel, or brass.

In making the windspinner's 8 top bearing assembly 15, provide a circular bushing 14 with a square cut out of its center so that when the assembly is put on the square generator shaft 7, the bushing 14 will remain in a fixed position.

Provide the bushing 14 with a channel-like recess 141 in its circular vertical dimension so that it can provide a “riding surface” for the assembly's 15 bearing 151.

The bearing 151 is a circular channel collar-like shape that has a horizontal projection out of its vertical dimension.

The channel portion of the bearing 151 receives and holds the top horizontal surface of the windspinner's 8 upper half 9.

This can be seen in FIG. 3.

In making the windspinner's bottom bearing assembly 45, provide a circular channel collar-like shape bearing 451 that has a downward projecting vertical skirt-like bushing which seats in and rides in a circular channel-like groove in the top surface of the bottom arm's 3 end piece 5. See FIG. 3.

Again with reference to FIG. 3, provide a veined windspinner turbine 8 that consists of two parts.

The windspinner 8 upper half 9 has alignment pins 11 that project downward.

The windspinner 8 lower half 10 has recessed holes 46 that alignment pins 11 fit into.

The upper and lower halves of the windspinner turbine 8 are held together by the top circular bushing 14 which is permanently fastened to the generator shaft 7, and the bottom end piece 5, and can be separated to permit access and servicing working parts within the windspinner 8 interior.

Continuing our reference to FIG. 3, note and provide a raised ridge 13 on the horizontal interior center surface of the turbine windspinner 8.

The raised ridge 13 surface is engaged by the center roller 26 of the device's spindle torque transmission system 5.

Provide vents 16 in the bottom surface of the lower half 10 of the windspinner 8 as a means for rain water to spin out.

The bottom surface of 10 is nearly horizontal.

B) A Turbine Windspinner Rotational Torque Transmission

With continued reference to FIG. 3, provide a windspinner 8 torque power transmission 50.

In the transmission 50 assembly 51, provide a rectangular frame 52 that has a top horizontal member 53, a bottom horizontal member 54, a left side vertical member 55, and a right side vertical member 56.

Note that the horizontal members 53 and 54 have an offset in their length dimension. This can be seen in FIG. 2.

At each corner of the rectangular transmission frame 52 provide a stabelizing fastener block 57, where two members are held together, and to facilitate making it a lightweight rectangular configuration.

Continuing the construction, provide two short arms 58 and 59 that are pivotally fastened to the rectangular frame's 52 top and bottom horizontal members 53 and 54, to flexibly support the frame 52 to the generator's shaft 7. This can be seen in FIG. 2.

And as shown in FIG. 2, provide an idler pulley 281, supported to a vertical post 282, carried extending upward out of the frame's 52 bottom horizontal member 54, and an idler pulley 283 supported to a post 284, carried extending upward from its flexible fastening function between short arm 59 and bottom horizontal member 54.

And again continuing, as shown in FIG. 3, provide a roller and pulley assembly 60 that is carried rotateably on a spindle 25 pipe, that rotates as a unit on the frame's 52 right side vertical member 56.

The spindle 25 carries two drive pulleys 27 that are spaced apart and have a roller 26 mounted between them.

The pulleys 27 and roller 26 are stationarily mounted on the spindle pipe 25.

The spindle assembly 60 is stabelized vertically by a bushing 47, that resembles a short length of pipe, at each end.

Again with reference to FIG. 2, provide a tension spting 44 between the generator shaft 7 and vertical frame member 55 to maintain a light pressure contact between center roller 26 and the raised horizontal interior center surface of the windspinner turbine 8, to facilitate transfer of rotational torque from the wind driven turbine to the generator's 1 transmission 50.

The outer surface of roller 26 and ridge surface 13 could be lightly coated with a non slip material for improved efficiency.

Further, provide a belt 17 that encompasses top spindle drive pulley 27 and the pulley shaped portion of the elongated hub pulley 19.

This belt 17 transmits counter clockwise rotational movement to the generator,s 1 magnetic line cutting armature 18.

Also provide a belt 17 that encompasses bottom spindle drive pulley 27 and idler pulley 281, and that is in peripheral contact with idler pulley 283, and flanged pulley 22.

This belt peripherally transmits clockwise movement to the generator 1 permanent magnet/electromagnet-brush spinner 21.

C) A Permanent Magnet/Electromagnet Field Spinner and a Multiple Radian Disk Armature

As shown in FIG. 3, provide a permanent magnet 23/electro magnet 53-brush spinner assembly 210.

In the 210 assembly provide a flanged pulley 22 that is rotateably contained on generator shaft 7 between a fixed bearing 20 beneath it, and the fixed bearing 20 beneath the elongated hub pulley 19, above it.

Provide a permanent magnet/electromagnet-brush spinner 21 frame 215 that is carried fastened to the top sides of the flanged pulley 22.

Within the spinner frame 215, at one end of the frame 215, provide a high energy type permanent horseshoe shaped magnet 23, fastened to the frame 215.

In the opposite end of the spinner frame 215, provide an iron horseshoe shape that is suitable for making an electromagnet 53, and on this shape, provide several wire 251 windings around the U portion of its horseshoe shape.

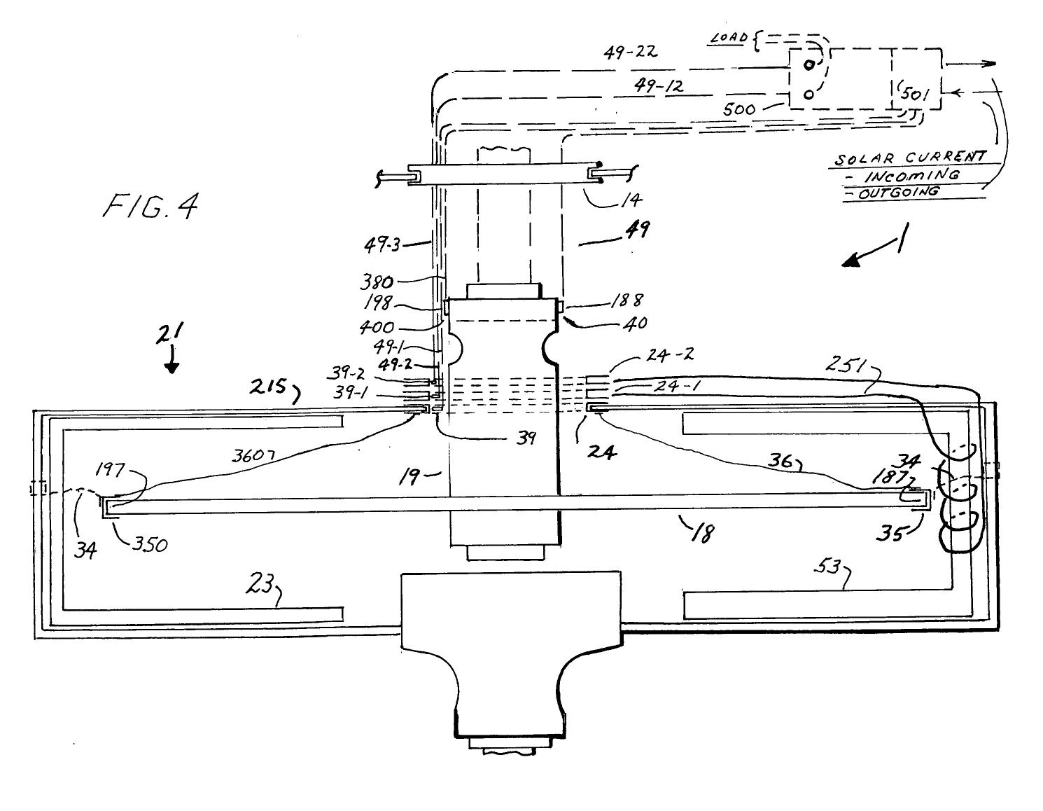

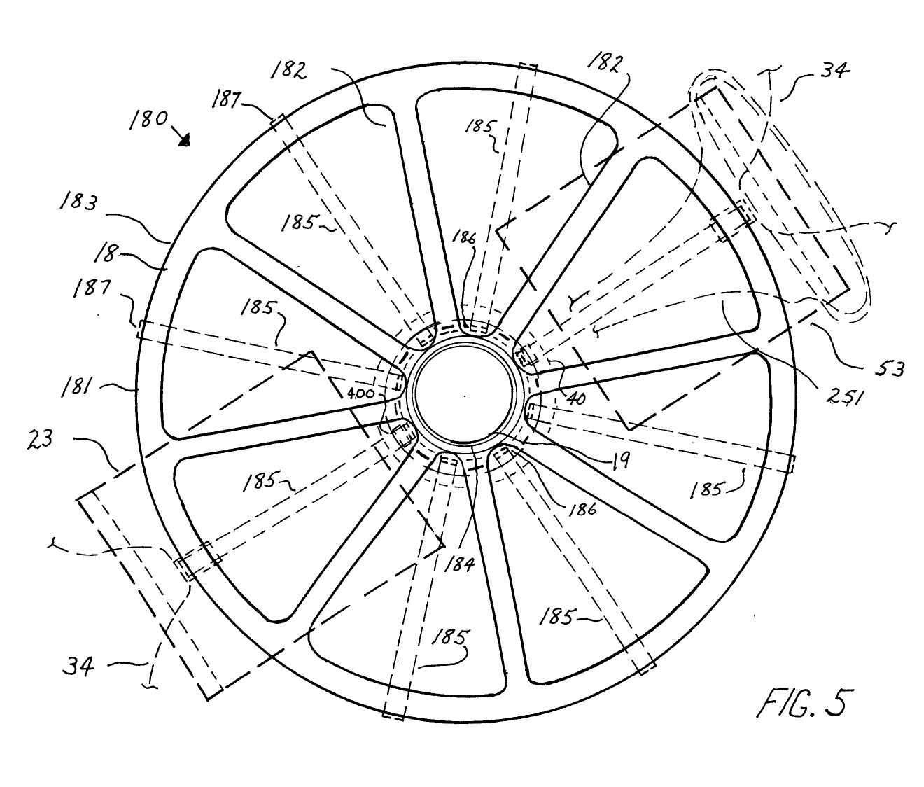

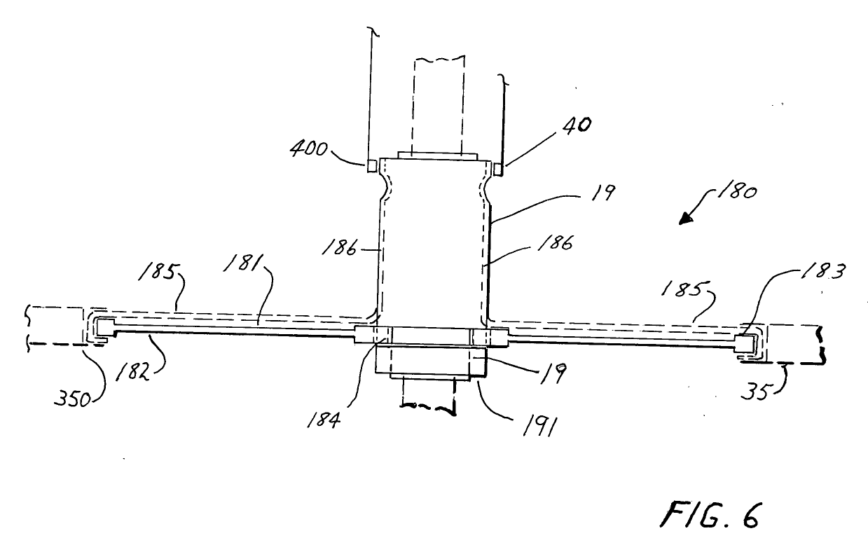

Continuing, and with reference to FIG. 4, FIG. 5, and FIG. 6, provide a generator 1 armature 18 assembly 180.

In the assembly 180, provide a disk frame 181 that has radian spokes 182 that support a circumference ring 183, and that resembles a spoked wheel.

The frame 181, spokes 182, and ring 183, could be made of thin lightweight plastic.

Fasten the frame 181 by its mounting hole 184, near the base of, on, and perpindicular to the vertical sides of elongated hub pulley 19. Stabelize the frame 181 by glueing a retaining ring 191 beneath it, on the base of the pulley 19.

Provide radian copper magnetic line cutter strips 185, fastened alternately between the spokes 182 of the frame 181.

With reference to FIG. 6, fasten each copper strip 185 in a groove 186, to the vertical face of the elongated hub pulley 19.

Extend the strip 185, vertically down the side of the pulley 19 to frame 181, then horizontally out to and over the edge of ring 183, then down over the vertical face of 183, and under the bottom surface of 183 as shown in FIG. 6.

The strip 185 could be fastened by glueing.

Each circuit strip 185 constitutes a single wire magnetic force line cutter 185, that extends between a brush point at the top of hub pulley 19's vertical face to a brush point on the surface of the strip 185 where it extends over, down, and under the armature 18 ring 183.

D) A Generator Circuit Means

Now, with reference to FIG. 4, provide the generator 1 with current circuit means on the right side of the generator 1 including, a brush 35 that sweeps the outer edge of armature 18 at brush point 187 the vertical face of the cutter strips 185, while it is carried supported to magnet-brush spinner 21 frame 215 by bracket 34, and including,
a connecting wire 36 from brush 35 to a circular conducting washer 24, that is carried in the center of the top long side of the spinner 21 frame, and including,
a secondary brush 39 that is carried on arm 49-1 supported to unit top bushing 14, while it sweeps conducting washer 24 and provides current circuit to one side of a battery charger 501, and including a brush 40 that sweeps a brush point 188, the vertical face of the cutter strips 185, at the top, right side of pulley hub 19, while carried on arm 49, supported to unit top bushing 14, and provides current circuit to the other side of battery charger 501.

Provide a battery 500 that is supported to unit support arm 3, and provide a battery charger 501 that is supported to and connected to the battery 500.

Now, again with reference to FIG. 4, provide current circuit means on the left side of the generator 1 including, a brush 350 that sweeps the outer edge of armature 18 at brush point 197, the vertical face of the cutter strips 185, while it is carried supported to magnet-brush spinner 21 frame 215 by bracket 34, and including, a connecting wire 360 from brush 350 to circular conducting washer 24, and shared use of the secondary brush 39 function in its sweep of washer 24 and its providing current circuit as indicated above, to one side of battery charger 501, and including,
a brush 400 that sweeps a brush point 198, the vertical face of the cutter strips 185, at the top, left side of pulley hub 19, while it is carried on arm 380, supported to unit top bushing 14, and provides current circuit, again, to the same side of the battery charger that brush 40 does.

Continuing, with reference to FIG. 4, provide circuit means for energizing the electromagnet 53.

Provide two circular conducting washers, 24-1 and 24-2, that are disposed insulated from each other and insulated from washer 24, and superimposed on and fastened on top of washer 24.

Washer 24-1, connected to one end of electromagnet wire 251, is swept by brush 39-1 which is supported on arm 49-2 to the unit top bushing 14.

Arm 49-2 is connected by wire 49-12 to one side of the battery 500.

Washer 24-2, connected to the other end of electromagnet wire 251, is swept by brush 39-2 which is supported on arm 49-3 to the unit top bushing.

Arm 49-3 is connected by wire 49-22 to the other side of battery 500.

Electromagnet 53 is energized by battery 500.

E) A Compliment Of Turbine Vein Mounted Electric Current Producing Solar Cells

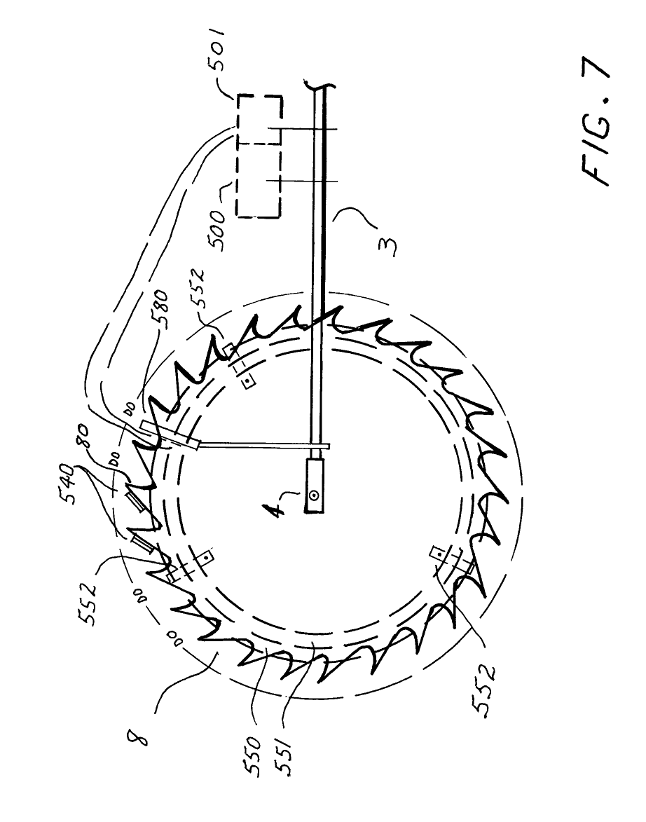

Continuing, now referring to FIG. 7, provide a panel 540 of electric current producing solar cells, one panel 540 glued to the face of each windspinner turbine 8 vein 80.

Also provide two concentric channel shaped current collectors, 550, a positive side channel, and 551, a negative side channel, where two channels are supported to the top surface of the turbine 8 with the opening of each channel facing upward, by brackets 552.

Connect each solar panel 540 by wire leads to the collector rings 550 and 551.

Also provide a dual collector ring current collecting brush 580 that is carried on the top windspinner 8 support arm 3.

The brush 580 sweeps current from rings 550 and 551 in circuit providing solar electric current to battery charger 501.

Concluding, again with reference to FIG. 5, note the positioning of the permanent magnet 23/electromagnet 53-brush, here simulated, with respect to achieving maximum magnetic line of force cutting effect by the generator's 1 copper armature 18 radian mag-line cutter strips 185.

1. A wind actuated electric power generation apparatus comprising wind actuated propulsion means including an outer surface with radially disposed vanes, an inner surface including means for transmitting fluid notion to an electrical generation apparatus, end surfaces including centrally located bearings allowing rotation of said propulsion means, a shaft passing throughsaid bearings, transmission means disposed in an enclosure formed by said inner surface and said end surfaces, and transmission receiving input motion from said inner surface transmitting means and outputting two rotation motions of opposite sense, and an electric generatorreceiving said opposite sensed motions, the improvement comprising structuring the generator as a Faraday Principle electric generator consisting essentially of an inner rotating mass containing metallic copper abd an oppositely rotating outer mass at least partially enclosing an inner rotating mass and comprising a permanent magnet.

2. The improved power generator of claim 1 wherein the transmission means comprises a cooperative assembly of pulleys and belts for transmitting said fluid motion to said electric generator.

3. The improved power generator of claim 2 wherein the generator is provided with a brush in electric conduction with the metallic copper of said inner rotating mass and in contact with the pulley which drives it and a brush in electric conduction with said metallic copper and mounted for support on said outer rotating magnet.

4. The improved power generator of claim 1 wherein said inner rotating mass constitutes an armature that is further comprised of a circular ring disk frame that has radian spokes and is carried on a pulley which drives it.

5. The improved power generator of claim 4 wherein said circular ring frame has narrow copper strip radians disposed between said spokes, fastened by their ends between said ring's outer circumference and the top edge of the pulley which drives the inner mass.

6. The improved power generator of claim 5 wherein each said copper strip constitutes a single wire, magnetic-line-of-force cutter, when said ring frame is rotated through a magnetic field.

7. The improved power generator of claim 1 wherein said opposotely rotating outer mass comprising a permanent magnet, further comprises an electromagnet, carried in combination with the permanent magnet, in the oppositely rotating outer mass.

8. The improved power generator of claim 3 wherein the generator, provided with a brush in electric conduction with the metallic copper of said inner rotating mass, and in contact with the pulley which drives it, and a brush in electric conduction with said metallic copper and mounted for support on said outer rotating magnet,
is also provided with a corresponding brush in electric conduction with the metallic copper of said inner rotating mass, and in contact with the pulley which drives it,
and a corresponding brush in electric conduction with said metallic copper and mounted for support on said outer rotating magnet,
where the corresponding configurations of said brushes are disposed, spaced 180° from each other.

9. The improved power generator of claim 5 wherein said copper strips are disposed spaced apart and insulated electrically from the pulley they are fastened to.

10. The improved power generator of claim 8 wherein the brush in contact with the pulley is insulated from the pulley top vertical surface where the surface is not faced with the vertical end of a copper strip.

11. The improved power generator of claim 7 wherein said electromagnet'magnet's wire leads are connected in circuit to a battery.

12. The improved generator of claim 11 wherein said battery is wired in circuit with a battery charger.

13. The improved power generator of claim 1 wherein said radially disposed vanes each has a vertically disposed solar panel fastened to its outer surface.

14. The improved generator of claim 13 wherein each solar panel is wired into two concentric horizontally disposed metal conductor channels mounted on top of said generator's top surface.

15. The improved generator of claim 14 wherein said metal conductor channels are swept by a dual pronged brush that has a negative side and a positive side and is mounted on the Faraday Principle generator's structural support.

16. The improved generator of claim 11 wherein said electromagnet current circuit further comprises a pair of circular conducting washers that bridge current from said battery directly, to, and energizing the electromagnet.

17. The improved generator of claim 15 wherein said solar current sweeping dual pronged brush is wired in circuit directly with said battery charger.

18. The improved generator of claim 8 wherein said corresponding configurations of brush and contact provided the generator are disposed, one within the influence of said permanent magnet magnetic-line-of-force field and the other within the influence of said electromagnet magnetic-line-of-force field,
where both configurations support current flow in circuit to the battery charger.
